(19) United States
(12) Patent Application Publication
(10) Pub. No.: US 2013/0128050 A1
(43) Pub. Date: May 23, 2013

(54) GEOGRAPHIC MAP BASED CONTROL

(71) Applicants: Farzin AGHDASI, Clovis, CA (US); Wei SU, Clovis, CA (US); Lei WANG, Clovis, CA (US)

(72) Inventors: Farzin AGHDASI, Clovis, CA (US); Wei SU, Clovis, CA (US); Lei WANG, Clovis, CA (US)

(21) Appl. No.: 13/302,984

(22) Filed: Nov. 22, 2011

(51) Int. Cl. H04N 7/18

(52) U.S. Cl. 348/158

(57) ABSTRACT

Disclosed are methods, systems, computer readable media and other implementations, including a method that includes determining, from image data captured by a plurality of cameras, motion data for multiple moving objects, and presenting, on a global image representative of areas monitored by the plurality of cameras, graphical indications of the determined motion data for the multiple objects at positions on the global image corresponding to geographic locations of the multiple moving objects. The method further includes presenting captured image data from one of the plurality of cameras in response to selection, based on the graphical indications presented on the global image, of an area of the global image presenting at least one of the graphical indications for at least one of the multiple moving objects captured by the one of the plurality of cameras.

### BACKGROUND

In traditional mapping applications, camera logos on a map may be selected to cause a window to pop up and to provide easy, instant access to live video, alarms, relays, etc. This makes it easier to configure and use maps in a surveillance system. However, few video analytics (e.g., selection of a camera based on some analysis of, for example, video content) are included during in this process.

### SUMMARY

The disclosure is directed to mapping applications, including mapping applications that include video features to enable detection of motions from cameras and to present motion trajectories on a global image (such as a geographic map, overhead view of the area being monitored, etc.) The mapping applications described herein help a guard, for example, to focus on a whole map instead of having to constantly monitor all the camera views. When there are any unusual signals or activities shown on the global image, the guard can click on a region of interest on the map, to thus cause the camera(s) in the chosen region to present the view in that region.

In some embodiments, a method is provided. The method includes determining, from image data captured by a plurality of cameras, motion data for multiple moving objects, and presenting, on a global image representative of areas monitored by the plurality of cameras, graphical indications of the determined motion data for the multiple objects at positions on the global image corresponding to geographic locations of the multiple moving objects. The method further includes presenting captured image data from one of the plurality of cameras in response to selection, based on the graphical indications presented on the global image, of an area of the global image presenting at least one of the graphical indications for at least one of the multiple moving objects captured by the one of the plurality of cameras.

Embodiments of the method may include at least some of the features described in the present disclosure, including one or more of the following features.

Presenting the captured image data in response to the selection of the area of the global image presenting the at least one of the graphical indications for the at least one of the multiple moving objects may include presenting captured image data from the one of the plurality of cameras in response to selection of a graphical indication corresponding to a moving object captured by the one of the plurality of cameras.

The method may further include calibrating at least one of the plurality of the cameras with the global image to match images of at least one area view captured by the at least one of the plurality of cameras to a corresponding at least one area of the global image.

Calibrating the at least one of the plurality of cameras may include selecting one or more locations appearing in an image captured by the at least one of the plurality of cameras, and identifying, on the global image, positions corresponding to the selected one or more locations in the image captured by the at least one of the plurality of cameras. The method may further include computing transformation coefficients, based on the identified global image positions and the corresponding selected one or more locations in the image of the at least one of the plurality of cameras, for a second-order 2-dimensional linear parametric model to transform coordinates of positions in images captured by the at least one of the plurality of cameras to coordinates of corresponding positions in the global image.

The method may further include presenting additional details of the at least one of the multiple moving objects corresponding to the at least one of the graphical indications in the selected area of the map, the additional details appearing in an auxiliary frame captured by an auxiliary camera associated with the one of the plurality of the cameras corresponding to the selected area.

Presenting the additional details of the at least one of the multiple moving objects may include zooming into an area in the auxiliary frame corresponding to positions of the at least one of the multiple moving objects captured by the one of the plurality of cameras.

Determining from the image data captured by the plurality of cameras motion data for the multiple moving objects may include applying to at least one image captured by at least one of the plurality of cameras a Gaussian mixture model to separate a foreground of the at least one image containing pixel groups of moving objects from a background of the at least one image containing pixel groups of static objects.

The motion data for the multiple moving objects comprises data for a moving object from the multiple moving objects may include one or more of, for example, location of the object within a camera's field of view, width of the object, height of the object, direction the object is moving, speed of the object, color of the object, an indication that the object is entering the field of view of the camera, an indication that the object is leaving the field of view of the camera, an indication that the camera is being sabotaged, an indication that the object is remaining in the camera's field of view for greater than a predetermined period of time, an indication that several moving objects are merging, an indication that the moving object is splitting into two or more moving objects, an indication that the object is entering an area of interest, an indication that the object is leaving a predefined zone, an indication that the object is crossing a tripwire, an indication that the object is moving in a direction matching a predefined forbidden direction for the zone or the tripwire, data representative of counting of the object, an indication of removal of the object, an indication of abandonment of the object, and/or data representative of a dwell timer for the object.

Presenting, on the global image, the graphical indications may include presenting, on the global image, moving geometrical shapes of various colors, the geometrical shapes including one or more of, for example, a circle, a rectangle, and/or a triangle.

Presenting, on the global image, the graphical indications may include presenting, on the global image, trajectories tracing the determined motion for at least one of the multiple objects at positions of the global image corresponding to geographic locations of a path followed by the at least one of the multiple moving objects.

In some embodiments, a system is provided. The system includes a plurality of cameras to capture image data, one or more display devices, and one or more processors configured to perform operations that include determining, from image data captured by a plurality of cameras, motion data for multiple moving objects, and presenting, on a global image representative of areas monitored by the plurality of cameras, using at least one of one or more display devices, graphical indications of the determined motion data for the multiple objects at positions on the global image corresponding to geographic locations of the multiple moving objects. The one or more processors are further configured to perform the operations of presenting, using one of the one or more display devices, captured image data from one of the plurality of cameras in response to selection, based on the graphical indications presented on the global image, of an area of the global image presenting at least one of the graphical indications for at least one of the multiple moving objects captured by the one of the plurality of cameras.

Embodiments of the system may include at least some of features described in the present disclosure, including at least some of the features described above in relation to the method.

In some embodiments, a non-transitory computer readable media is provided. The computer readable media is programmed with a set of computer instructions executable on a processor that, when executed, cause operations including determining, from image data captured by a plurality of cameras, motion data for multiple moving objects, and presenting, on a global image representative of areas monitored by the plurality of cameras, graphical indications of the determined motion data for the multiple objects at positions on the global image corresponding to geographic locations of the multiple moving objects. The set of computer instructions further includes instructions that cause the operations of presenting captured image data from one of the plurality of cameras in response to selection, based on the graphical indications presented on the global image, of an area of the global image presenting at least one of the graphical indications for at least one of the multiple moving objects captured by the one of the plurality of cameras.

Embodiments of the computer readable media may include at least some of features described in the present disclosure, including at least some of the features described above in relation to the method and the system.

As used herein, the term “about” refers to a +/−10% variation from the nominal value. It is to be understood that such a variation is always included in a given value provided herein, whether or not it is specifically referred to.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

Unless defined otherwise, all technical and scientific terms used herein have the same meaning as commonly understood by one of ordinary skill in the art to which this disclosure belongs.

Details of one or more implementations are set forth in the accompanying drawings and in the description below. Further features, aspects, and advantages will become apparent from the description, the drawings, and the claims.

### BRIEF DESCRIPTION OF THE FIGURES

FIG. 1A is a block diagram of a camera network.

FIG. 1B is a schematic diagram of an example embodiment of a camera.

FIG. 2 is a flowchart of an example procedure to control operations of cameras using a global image.

FIG. 3 is a photo of a global image of an area monitored by multiple cameras.

FIG. 4 is a diagram of a global image and a captured image of at least a portion of the global image.

FIG. 5 is a flowchart of an example procedure to identify moving objects and determine their motions and/or other characteristics.

FIG. 6 is a flowchart of an example embodiment of a camera calibration procedure.

FIGS. 7A and 7B are a captured image and a global overhead image with selected calibration points to facilitate a calibration operation of a camera that captured the image of FIG. 7A.

FIG. 8 is a schematic diagram of a generic computing system.

Like reference symbols in the various drawings indicate like elements.

### DETAILED DESCRIPTION

Disclosed herein are methods, systems, apparatus, devices, products and other implementations, including a method that includes determining from image data captured by multiple cameras motion data for multiple moving objects, and presenting on a global image, representative of areas monitored by the multiple cameras, graphical movement data items (also referred to as graphical indications) representative of the determined motion data for the multiple moving objects at positions of the global image corresponding to geographic locations of the multiple moving objects. The method further includes presenting captured image data from one of the multiple cameras in response to selection, based on the graphical movement data items presented on the global image, of an area of the global image presenting at least one of the graphical indications (also referred to as graphical movement data items) for at least one of the multiple moving objects captured by (appearing in) the one of the multiple cameras.

Implementations configured to enable presenting motion data for multiple objects on a global image (e.g., a geographic map, an overhead image of an area, etc.) include implementations and techniques to calibrate cameras to the global image (e.g., to determine which positions in the global image correspond to positions in an image captured by a camera), and implementations and techniques to identify and track moving objects from images captured by the cameras of a camera network.

### System Configuration and Camera Control Operations

Generally, each camera in a camera network has an associated point of view and field of view. A point of view refers to the position and perspective from which a physical region is being viewed by a camera. A field of view refers to the physical region imaged in frames by the camera. A camera that contains a processor, such as a digital signal processor, can process frames to determine whether a moving object is present within its field of view. The camera may, in some embodiments, associate metadata with images of the moving object (referred to as “object” for short). Such metadata defines and represents various characteristics of the object. For instance, the metadata can represent the location of the object within the camera's field of view (e.g., in a 2-D coordinate system measured in pixels of the camera's CCD), the width of the image of the object (e.g., measured in pixels), the height of image of the object (e.g., measured in pixels), the direction the image of the object is moving, the speed of the image of the object, the color of the object, and/or a category of the object. These are pieces of information that can be present in metadata associated with images of the object; other types of information for inclusion in a metadata are also possible. The category of object refers to a category, based on other characteristics of the object, that the object is determined to be within. For example, categories can include: humans, animals, cars, small trucks, large trucks, and/or SUVs. Determination of an object's categories may be performed, for example, using such techniques as image morphology, neural net classification, and/or other types of image processing techniques/procedures to identify objects. Metadata regarding events involving moving objects may also be transmitted by the camera (or a determination of such events may be performed remotely) to the host computer system. Such event metadata include, for example, an object entering the field of view of the camera, an object leaving the field of view of the camera, the camera being sabotaged, the object remaining in the camera's field of view for greater than a threshold period of time (e.g., if a person is loitering in an area for greater than some threshold period of time), multiple moving objects merging (e.g., a running person jumps into a moving vehicle), a moving object splitting into multiple moving objects (e.g., a person gets out of a vehicle), an object entering an area of interest (e.g., a predefined area where the movement of objects is desired to be monitored), an object leaving a predefined zone, an object crossing a tripwire, an object moving in a direction matching a predefined forbidden direction for a zone or tripwire, object counting, object removal (e.g., when an object is still/stationary for longer than a predefined period of time and its size is larger than a large portion of a predefined zone), object abandonment (e.g., when an object is still for longer than a predefined period of time and its size is smaller than a large portion of a predefined zone), and a dwell timer (e.g., the object is still or moves very little in a predefined zone for longer than a specified dwell time).

Each of a plurality of cameras may transmit data representative of motion and other characteristics of objects (e.g., moving objects) appearing in the view of the respective cameras to a host computer system and/or may transmit frames of a video feed (possibly compressed) to the host computer system. Using the data representative of the motion and/or other characteristics of objects received from multiple cameras, the host computer system is configured to present motion data for the objects appearing in the images captured by the cameras on a single global image (e.g., a map, an overhead image of the entire area covered by the cameras, etc.) so as to enable a user to see a graphical representation of movement of multiple objects (including the motion of objects relative to each other) on the single global image. The host computer can enable a user to select an area from that global image and receive a video feed from a camera(s) capturing images from that area.

In some implementations, the data representative of motion (and other object characteristics) may be used by a host computer to perform other functions and operations. For example, in some embodiments, the host computer system may be configured to determine whether images of moving objects that appear (either simultaneously or non-simultaneously) in the fields of view of different cameras represent the same object. If a user specifies that this object is to be tracked, the host computer system displays to the user frames of the video feed from a camera determined to have a preferable view of the object. As the object moves, frames may be displayed from a video feed of a different camera if another camera is determined to have the preferable view. Therefore, once a user has selected an object to be tracked, the video feed displayed to the user may switch from one camera to another based on which camera is determined to have the preferable view of the object by the host computer system. Such tracking across multiple cameras' fields of view can be performed in real time, that is, as the object being tracked is substantially in the location displayed in the video feed. This tracking can also be performed using historical video feeds, referring to stored video feeds that represent movement of the object at some point in the past. Additional details regarding such further functions and operations are provided, for example, in patent application Ser. No. 12/982,138, entitled “Tracking Moving Objects Using a Camera Network,” filed Dec. 30, 2010, the content of which is hereby incorporated by reference in its entirety.

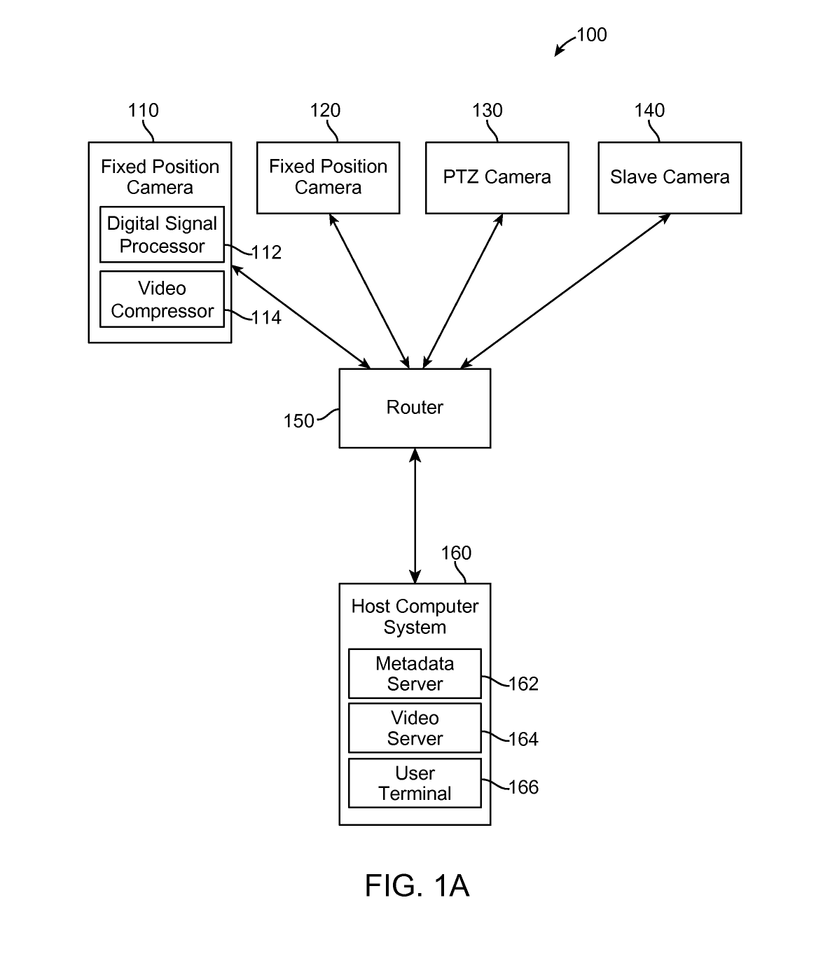

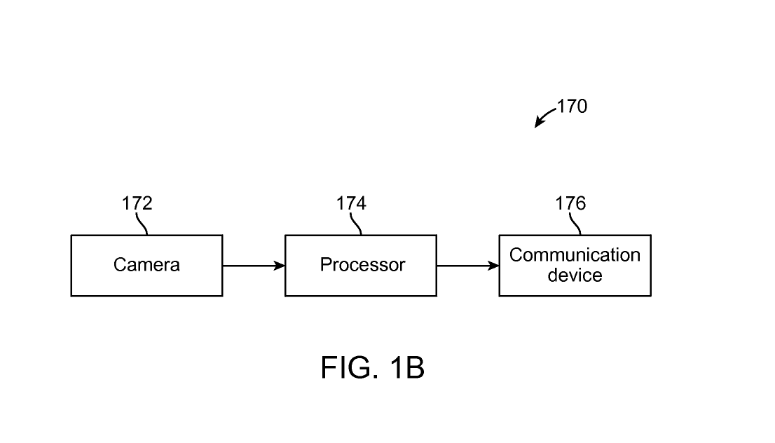

With reference to FIG. 1A, an illustration of a block diagram of a security camera network 100 is shown. Security camera network 100 includes a plurality of cameras which may be of the same or different types. For example, in some embodiments, the camera network 100 may include one or more fixed position cameras (such as cameras 110 and 120), one or more PTZ (Pan-Tilt-Zoom) camera 130, one or more slave camera 140 (e.g., a camera that does not perform locally any image/video analysis, but instead transmits captures images/frames to a remote device, such as a remote server). Additional or fewer cameras, of various types (and not just one of the camera types depicted in FIG. 1), may be deployed in the camera network 100, and the camera networks 100 may have zero, one, or more than one of each type of camera. For example, a security camera network could include five fixed cameras and no other types of cameras. As another example, a security camera network could have three fixed position cameras, three PTZ cameras, and one slave camera. As will be described in greater detail below, in some embodiments, each camera may be associated with a companion auxiliary camera that is configured to adjust its attributes (e.g., spatial position, zoom, etc.) to obtain additional details about particular features that were detected by its associated “principal” camera so that the principal camera's attributes do not have to be changed.

The security camera network 100 also includes router 150. The fixed position cameras 110 and 120, the PTZ camera 130, and the slave camera 140 may communicate with the router 150 using a wired connection (e.g., a LAN connection) or a wireless connection. Router 150 communicates with a computing system, such as host computer system 160. Router 150 communicates with host computer system 160 using either a wired connection, such as a local area network connection, or a wireless connection. In some implementations, one or more of the cameras 110, 120, 130, and/or 140 may transmit data (video and/or other data, such as metadata) directly to the host computer system 160 using, for example, a transceiver or some other communication device. In some implementations, the computing system may be a distributed computer system.

The fixed position cameras 110 and 120 may be set in a fixed position, e.g., mounted to the eaves of a building, to capture a video feed of the building's emergency exit. The field of view of such fixed position cameras, unless moved or adjusted by some external force, will remain unchanged. As shown in FIG. 1A, fixed position camera 110 includes a processor 112, such as a digital signal processor (DSP), and a video compressor 114. As frames of the field of view of fixed position camera 110 are captured by fixed position camera 110, these frames are processed by digital signal processor 112, or by a general processor, to determine, for example, if one or more moving objects are present and/or to perform other functions and operations.

More generally, and with reference to FIG. 1B, a schematic diagram of an example embodiment of a camera 170 (also referred to as a video source) is shown. The configuration of the camera 170 may be similar to the configuration of at least one of the cameras 110, 120, 130, and/or 140 depicted in FIG. 1A (although each of the cameras 110, 120, 130, and/or 140 may have features unique to it, e.g., the PTZ camera may be able be spatially displaced to control the parameters of the image captured by it). The camera 170 generally includes a capture unit 172 (sometimes referred to as the “camera” of a video source device) that is configured to provide raw image/video data to a processor 174 of the camera 170. The capture unit 172 may be a charge-coupled device (CCD) based capture unit, or may be based on other suitable technologies. The processor 174 electrically coupled to the capture unit can include any type processing unit and memory. Additionally, the processor 174 may be used in place of, or in addition to, the processor 112 and video compressor 114 of the fixed position camera 110. In some implementations, the processor 174 may be configured, for example, to compress the raw video data provided to it by the capture unit 172 into a digital video format, e.g., MPEG. In some implementations, and as will become apparent below, the processor 174 may also be configured to perform at least some of the procedures for object identification and motion determination. The processor 174 may also be configured to perform data modification, data packetization, creation of metadata, etc. Resultant processed data, e.g., compressed video data, data representative of objects and/or their motions (for example, metadata representative of identifiable features in the captured raw data) is provided (streamed) to, for example, a communication device 176 which may be, for example, a network device, a modem, wireless interface, various transceiver types, etc. The streamed data is transmitted to the router 150 for transmission to, for example, the host computer system 160. In some embodiments, the communication device 176 may transmit data directly to the system 160 without having to first transmit such data to the router 150. While the capture unit 172, the processor 174, and the communication device 176 have been shown as separate units/devices, their functions can be provided in a single device or in two devices rather than the three separate units/devices as illustrated.

In some embodiments, a scene analyzer procedure may be implemented in the capture unit 172, the processor 174, and/or a remote workstation, to detect an aspect or occurrence in the scene in the field of view of camera 170 such as, for example, to detect and track an object in the monitored scene. In circumstances in which scene analysis processing is performed by the camera 170, data about events and objects identified or determined from captured video data can be sent as metadata, or using some other data format, that includes data representative of objects' motion, behavior and characteristics (with or without also sending video data) to the host computer system 160. Such data representative of behavior, motion and characteristics of objects in the field of views of the cameras can include, for example, the detection of a person crossing a trip wire, the detection of a red vehicle, etc. As noted, alternatively and/or additionally, the video data could be streamed over to the host computer system 160 for processing and analysis may be performed, at least in part, at the host computer system 160.

More particularly, to determine if one or more moving objects are present in image/video data of a scene captured by a camera such as the camera 170, processing is performed on the captured data. Examples of image/video processing to determine the presence and/or motion and other characteristics of one or more objects are described, for example, in patent application Ser. No. 12/982,601, entitled “Searching Recorded Video,” the content of which is hereby incorporated by reference in its entirety. As will be described in greater details below, in some implementations, a Gaussian mixture model may be used to separate a foreground that contains images of moving objects from a background that contains images of static objects (such as trees, buildings, and roads). The images of these moving objects are then processed to identify various characteristics of the images of the moving objects.

As noted, data generated based on images captured by the cameras may include, for example, information on characteristics such as location of the object, height of the object, width of the object, direction the object is moving in, speed the object is moving at, color of the object, and/or a categorical classification of the object.

For example, the location of the object, which may be represented as metadata, may be expressed as two-dimensional coordinates in a two-dimensional coordinate system associated with one of the cameras. Therefore, these two-dimensional coordinates are associated with the position of the pixel group constituting the object in the frames captured by the particular camera. The two-dimensional coordinates of the object may be determined to be a point within the frames captured by the cameras. In some configurations, the coordinates of the position of the object is deemed to be the middle of the lowest portion of the object (e.g., if the object is a person standing up, the position would be between the person's feet). The two dimensional coordinates may have an x and y component. In some configurations, the x and y components are measured in numbers of pixels. For example, a location of {613, 427} would mean that the middle of the lowest portion of the object is 613 pixels along the x-axis and 427 pixels along they-axis of the field of view of the camera. As the object moves, the coordinates associated with the location of the object would change. Further, if the same object is also visible in the fields of views of one or more other cameras, the location coordinates of the object determined by the other cameras would likely be different.

The height of the object may also be represented using, for example, metadata, and may be expressed in terms of numbers of pixels. The height of the object is defined as the number of pixels from the bottom of the group of pixels constituting the object to the top of the group of pixels of the object. As such, if the object is close to the particular camera, the measured height would be greater than if the object is further from the camera. Similarly, the width of the object may also be expressed in terms of a number of pixels. The width of the objects can be determined based on the average width of the object or the width at the object's widest point that is laterally present in the group of pixels of the object. Similarly, the speed and direction of the object can also be measured in pixels.

With continued reference to FIG. 1A, in some embodiments, the host computer system 160 includes a metadata server 162, a video server 164, and a user terminal 166. The metadata server 162 is configured to receive, store, and analyze metadata (or some other data format) received from the cameras communicating with host computer system 160. Video server 164 may receive and store compressed and/or uncompressed video from the cameras. User terminal 166 allows a user, such as a security guard, to interface with the host system 160 to, for example, select from a global image, on which data items representing multiple objects and their respective motions are presented, an area that the user wishes to study in greater details. In response to selection of the area of interest from the global image presented on a screen/monitor of the user terminal, video data and/or associated metadata corresponding to one of the plurality of camera deployed in the network 100 is presented to the user (in place of or in addition to the presented global image on which the data items representative of the multiple objects are presented. In some embodiments, user terminal 166 can display one or more video feeds to the user at one time. In some embodiments, the functions of metadata server 162, video server 164, and user terminal 166 may be performed by separate computer systems. In some embodiments, such functions may be performed by one computer system.

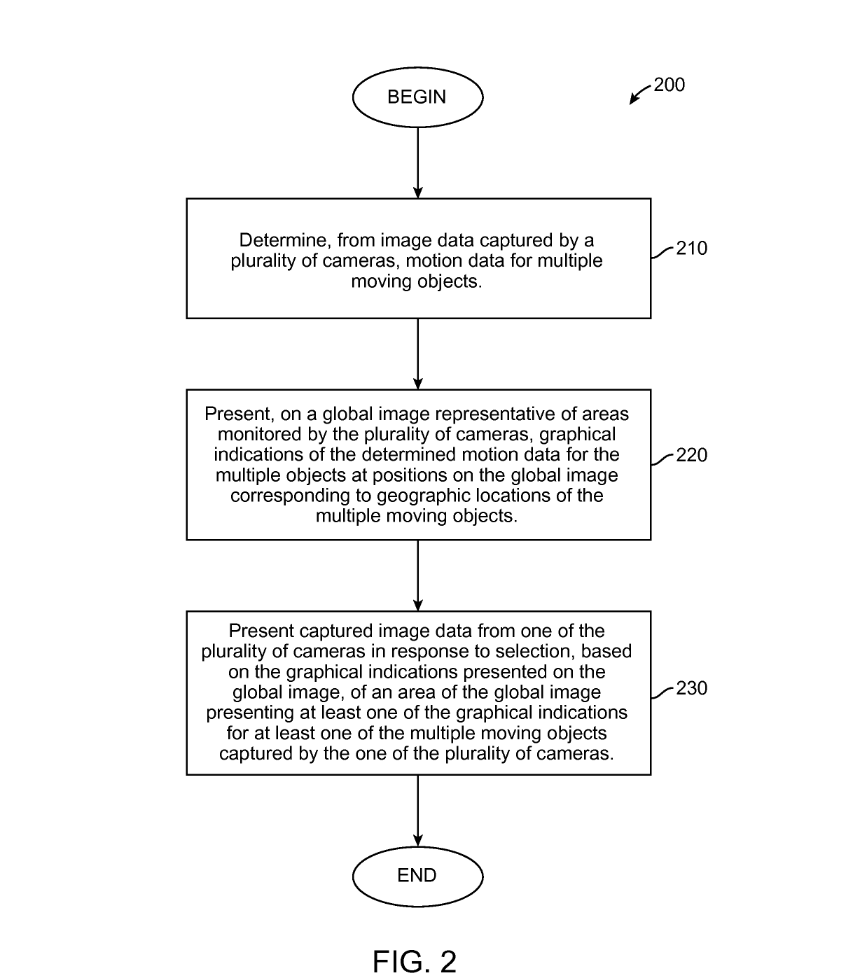

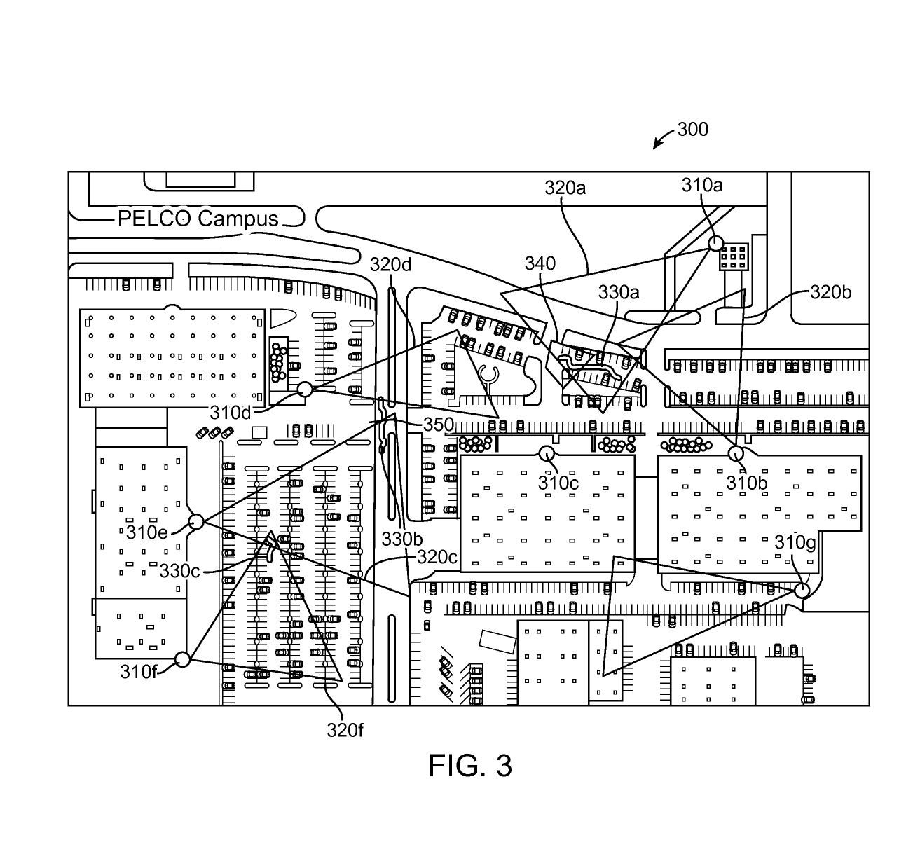

More particularly, with reference to FIG. 2, a flowchart of an example procedure 200 to control operation of cameras using a global image (e.g., a geographic map) is shown. Operation of the procedure 200 is also described with reference to FIG. 3, showing a global image 300 of an area monitored by multiple cameras (which may be similar to any of the cameras depicted in FIGS. 1A and 1B).

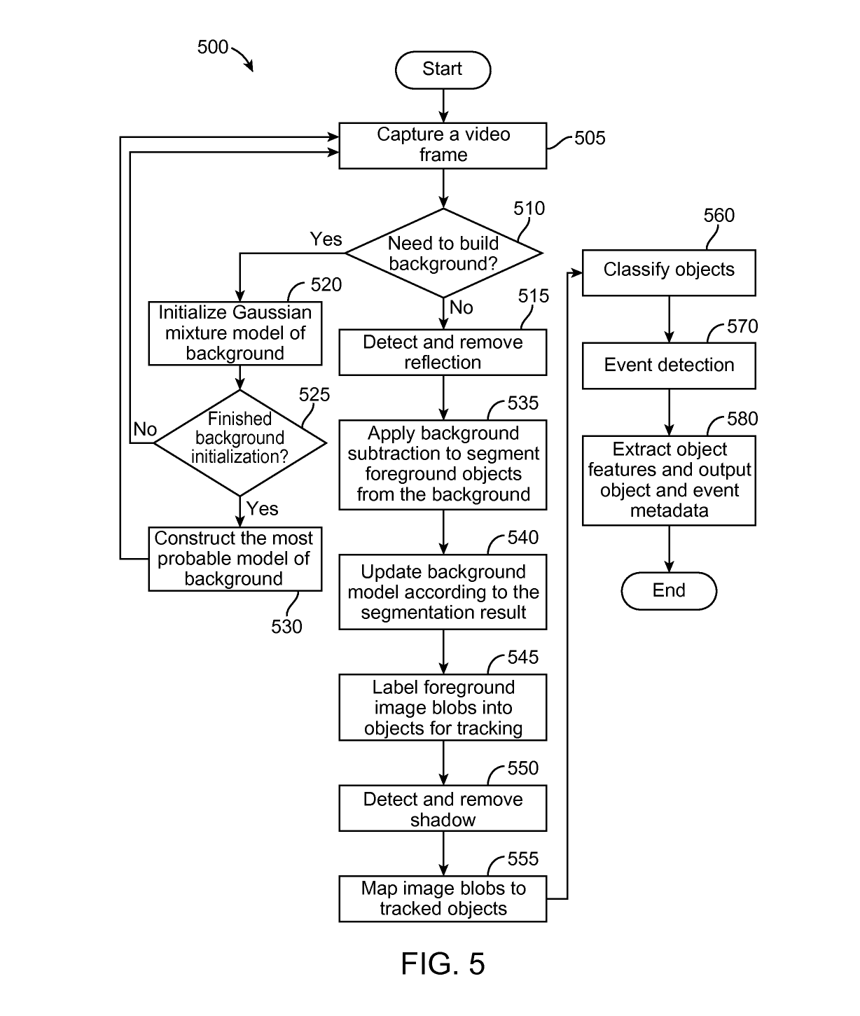

The procedure 200 includes determining 210 from image data captured by a plurality of cameras motion data for multiple moving objects. Example embodiments of procedures to determine motion data are described in greater detail below in relation to FIG. 5. As noted, motion data may be determined at the cameras themselves, where local camera processors (such as the processor depicted at in FIG. 1B) process captured video images/frames to, for example, identify moving objects in the frames from non-moving background features. In some implementations, at least some of the processing operations of the images/frames may be performed at a central computer system, such as the host computer system 160 depicted in FIG. 1A. Processed frames/image resulting in data representative of motion of identified moving object and/or representative of other object characteristics (such as object size, data indicative of certain events, etc.) are used by the central computer system to present/render 220 on a global image, such as the global image 300 of FIG. 3, graphical indications of the determined motion data for the multiple objects at positions of the global image corresponding to geographic locations of the multiple moving objects.

In the example of FIG. 3, the global image is an overhead image of a campus (the “Pelco Campus”) comprising several buildings. In some embodiments, the locations of the cameras and their respective fields of view may be rendered in the image 300, thus enabling a user to graphically view the locations of the deployed cameras and to select a camera that would provide video stream of an area of the image 300 the user wishes to view. The global image 300, therefore, includes graphical representations (as darkened circles) of cameras 310a-g, and also includes a rendering of a representation of the approximate respective field of views 320a-f for the cameras 310a-b and 310d-g. As shown, in the example of FIG. 3 there is no field of view representation for the camera 310c, thus indicating that the camera 310c is not currently active.

As further shown in FIG. 3, graphical indications of the determined motion data for the multiple objects at positions of the global image corresponding to geographic locations of the multiple moving objects are presented. For example, in some embodiments, trajectories, such as trajectories 330a-c shown in FIG. 3, representing the motions of at least some of the objects present in the images/video captured by the cameras, may be rendered on the global image. Also shown in FIG. 3 is a representation of a pre-defined zone 340 defining a particular area (e.g., an area designated as an off-limits area) which, when breached by a moveable object, causes an event detection to occur. Similarly, FIG. 3 may further graphically represent tripwires, such as the tripwire 350, which, when crossed, cause an event detection to occur

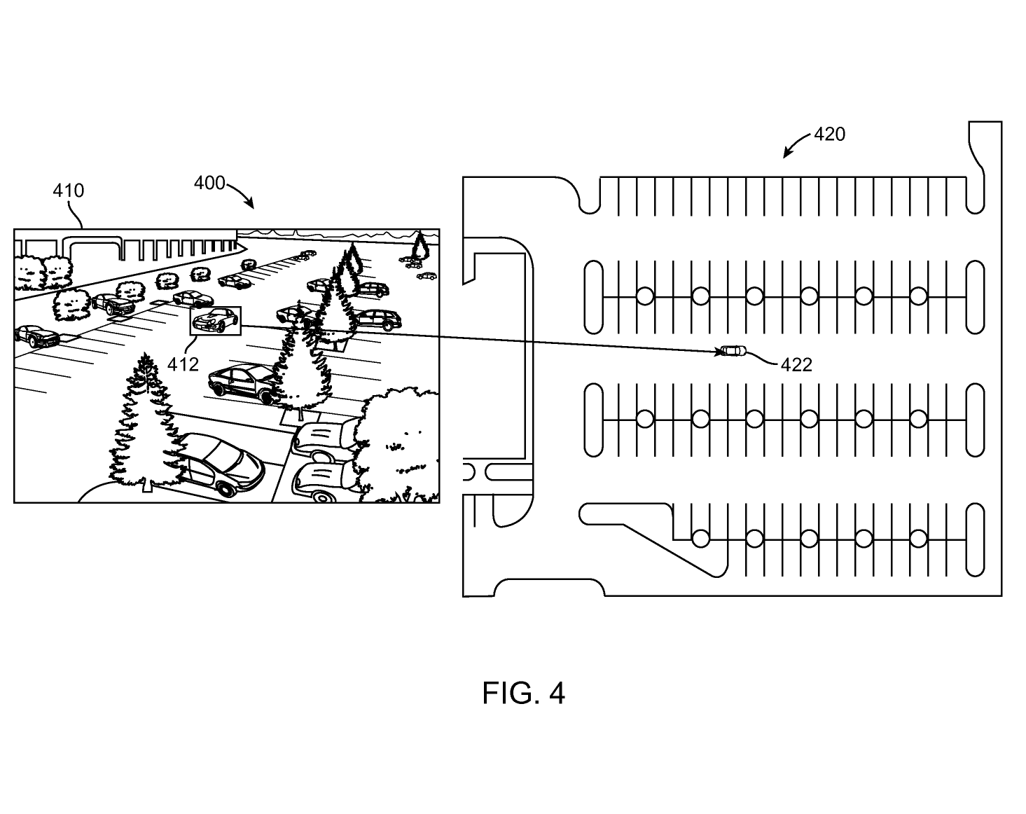

In some embodiments, the determined motion of at least some of the multiple objects may be represented as a graphical representation changing its position on the global image 300 over time. For example, with reference to FIG. 4, a diagram 400 that includes a photo of a captured image 410 and of a global image 420 (overhead image), that includes the area in the captured image 410, are shown. The captured image 410 shows a moving object 412, namely, a car, that was identified and its motion determined (e.g., through image/frame processing operations such as those described herein). A graphical indication (movement data item) 422, representative of the determined motion data for the moving object 412 is presented on the global image 420. The graphical indication 422 is presented as, in this example, a rectangle that moves in a direction determined through image/frame processing. The rectangle 422 may be of a size and shape that is representative of the determined characteristics of the objects (i.e., the rectangle may have a size that is commensurate with the size of the car 412, as may be determined through scene analysis and frame processing procedures). The graphical indications may also include, for example, other geometric shapes and symbol representative of the moving object (e.g., a symbol or icon of a person, a car), and may also include special graphical representations (e.g., different color, different shapes, different visual and/or audio effects) to indicate the occurrence of certain events (e.g., the crossing of a trip wire, and/or other types of events as described herein).

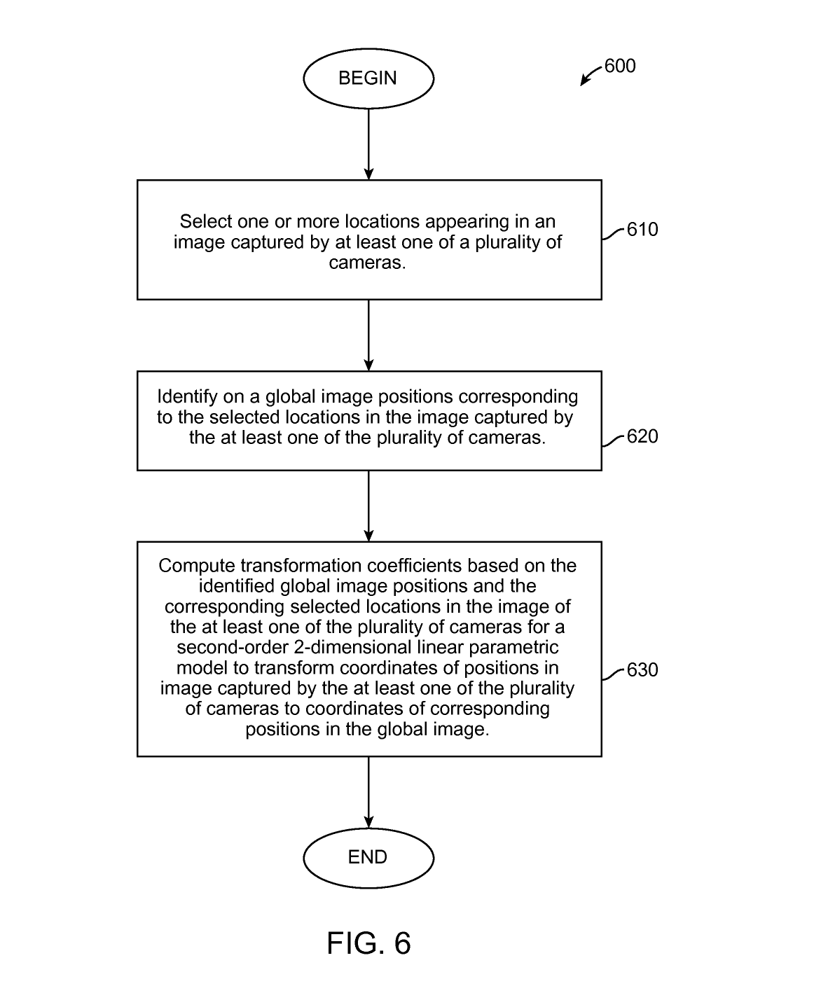

In order to present graphical indications at positions in the global image that substantially represent the corresponding moving objects' geographical positions, the cameras have to be calibrated to the global image so that the camera coordinates (positions) of the moving objects identified from frames/images captured by those cameras are transformed to global image coordinates (also referred to as “world coordinates”). Details of example calibration procedures to enable rendering of graphical indications (also referred to as graphical movement items) at positions substantially matching the geographic positions of the corresponding identified moving objects determined from captured video frames/images are provided below in relation to FIG. 6.

Turning back to FIG. 2, based on the graphical indications presented on the global image, captured image/video data from one of the plurality of cameras is presented (230) in response to selection of an area of the map at which at least one of the graphical indications, representative of at least one of the multiple moving objects captured by the one of the cameras. For example, a user (e.g., a guard) is able to have a representative single view (namely, the global image) of the areas monitored by all the cameras deployed, and thus to monitor motions of identified objects. When the guard wishes to obtain more details about a moving object, for example, a moving object corresponding to a traced trajectory (e.g., displayed, for example, as a red curve), the guard can click or otherwise select an area/region on the map where the particular object is shown to be moving to cause video stream from a camera associated with that region to be presented to the user. For example, the global image may be divided into a grid of areas/regions which, when one of them is selected, causes video streams from the camera(s) covering that selected area to be presented. In some embodiments, the video stream may be presented to the user alongside the global image on which motion of a moving object identified from frames of that camera is presented to the user. FIG. 4, for example, shows a video frame displayed alongside a global image in which movement of a moving car from the video frame is presented as a moving rectangle.

In some embodiments, presenting captured image data from the one of the cameras may be performed in response to selection of a graphical indication, corresponding to a moving object, from the global image. For example, a user (such as a guard) may click on the actual graphical movement data item (be it a moving shape, such as a rectangle, or a trajectory line) to cause video streams from camera(s) capturing the frames/images from which the moving object was identified (and its motion determined) to be presented to the user. As will described in greater details below, in some implementations, the selection of the graphical movement items representing a moving object and/or its motion may cause an auxiliary camera associated with the camera in which the moving object, corresponding to the selected graphical movement item appears, to zoom in on the area where the moving object is determined to be located to thus provide more details for that object.

### Object Identification and Motion Determination Procedures

Identification of the objects to be presented on the global image (such as the global image 300 or 420 shown in FIGS. 3 and 4, respectively) from at least some of images/videos captured by at least one of a plurality of cameras, and determination and tracking of motion of such objects, may be performed using the procedure 500 depicted in FIG. 5. Additional details and examples of image/video processing to determine the presence of one or more objects and their respective motions are provided, for example, in patent application Ser. No. 12/982,601, entitled “Searching Recorded Video.”

Briefly, the procedure 500 includes capturing 505 a video frame using one of the cameras deployed in the network (e.g., in the example of FIG. 3, cameras are deployed at locations identified using the dark circles 310a-g). The cameras capturing the video frame may be similar to any of the cameras 110, 120, 130, 140, and/or 170 described herein in relations to FIGS. 1A and 1B. Furthermore, although the procedure 500 is described in relation to a single camera, similar procedures may be implemented using other of the cameras deployed to monitor the areas in question. Additionally, video frames can be captured in real time from a video source or retrieved from data storage (e.g., in implementations where the cameras include a buffer to temporarily store captured images/video frames, or from a repository storing a large volume of previously captured data). The procedure 500 may utilize a Gaussian model to exclude static background images and images with repetitive motion without semantic significance (e.g., trees moving in the wind) to thus effectively subtract the background of the scene from the objects of interest. In some embodiments, a parametric model is developed for grey level intensity of each pixel in the image. One example of such a model is the weighted sum of a number of Gaussian distributions. If we choose a mixture of 3 Gaussians, for instance, the normal grey level of such a pixel can be described by 6 parameters, 3 numbers for averages, and 3 numbers for standard deviations. In this way, repetitive changes, such as the movement of branches of a tree in the wind, can be modeled. For example, in some implementations, embodiments, three favorable pixel values are kept for each pixel in the image. Once any pixel value falls in one of the Gaussian models, the probability is increased for the corresponding Gaussian model and the pixel value is updated with the running average value. If no match is found for that pixel, a new model replaces the least probable Gaussian model in the mixture model. Other models may also be used.

Thus, for example, in order to detect objects in the scene, a Gaussian mixture model is applied to the video frame (or frames) to create the background, as more particularly shown blocks 510, 520, 525, and 530. With this approach, a background model is generated even if the background is crowded and there is motion in the scene. Because Gaussian mixture modeling can be time consuming for real-time video processing, and is hard to optimize due to its computation properties, in some implementations, the most probable model of the background is constructed (at 530) and applied (at 535) to segment foreground objects from the background. In some embodiments, various other background construction and training procedures may be used to create a background scene.

In some implementations, a second background model can be used in conjunction with the background model described above or as a standalone background model. This can be done, for example, in order to improve the accuracy of object detection and remove false objects detected due to an object that has moved away from a position after it stayed there for a period of time. Thus, for example, a second “long-term” background model can be applied after a first “short-term” background model. The construction process of a long-term background may be similar to that as the short-term background model, except that it updates at a much slower rate. That is, generating a long-term background model may be based on more video frames and/or may be performed over a longer period of time. If an object is detected using the short-term background, yet an object is considered part of the background from the long-term background, then the detected object may be deemed to be a false object (e.g., an object that remained in one place for a while and left). In such a case, the object area of the short-term background model may be updated with that of the long-term background model. Otherwise, if an object appears in the long-term background but is determined to be part of the background when processing the frame using the short-term background model, then the object has merged into the short-term background. If an object is detected in both of background models, then the likelihood that the item/object in question is a foreground object is high.

Thus, as noted, a background subtraction operation is applied (at 535) to a captured image/frame (using a short-term and/or a long-term background model) to extract the foreground pixels. The background model may be updated 540 according to the segmentation result. Since the background generally does not change quickly, it is not necessary to update the background model for the whole image in each frame. However, if the background model is updated every N (N>0) frames, the processing speeds for the frame with background updating and the frame without background updating are significantly different and this may at times cause motion detection errors. To overcome this problem, only a part of the background model may be updated in every frame so that the processing speed for every frame is substantially the same and speed optimization is achieved.

The foreground pixels are grouped and labeled 545 into image blobs, groups of similar pixels, etc., using, for example, morphological filtering, which includes non-linear filtering procedures applied to an image. In some embodiments, morphological filtering may include erosion and dilation processing. Erosion generally decreases the sizes of objects and removes small noises by subtracting objects with a radius smaller than the structuring element (e.g., 4-neightbor or 8-neightbor). Dilation generally increases the sizes of objects, filling in holes and broken areas, and connecting areas that are separated by spaces smaller than the size of the structuring element. Resultant image blobs may represent the moveable objects detected in a frame. Thus, for example, morphological filtering may be used to remove “objects” or “blobs” that are made up of, for example, a single pixel scattered in an image. Another operation may be to smooth the boundaries of a larger blob. In this way noise is removed and the number of false detection of objects is reduced.

As further shown in FIG. 5, reflection present in the segmented image/frame can be detected and removed from the video frame. To remove the small noisy image blobs due to segmentation errors and to find a qualified object according to its size in the scene, a scene calibration method, for example, may be utilized to detect the blob size. For scene calibration, a perspective ground plane model is assumed. For example, a qualified object should be higher than a threshold height (e.g., minimal height) and narrower than a threshold width (e.g., maximal width) in the ground plane model. The ground plane model may be calculated, for example, via designation of two horizontal parallel line segments at different vertical levels, and the two line segments should have the same length as the real world length of a vanishing point (e.g., a point in a perspective drawing to which parallel lines appear to converge) of the ground plane so that the actual object size can be calculated according to its position to the vanishing point. The maximal/minimal width/height of a blob is defined at the bottom of the scene. If the normalized width/height of a detected image blob is smaller than the minimal width/height or the normalized width/height is wider than the maximal width/height, the image blob may be discarded. Thus, reflections and shadows can be detected and removed 550 from the segmented frame.

Reflection detection and removal can be conducted before or after shadow removal. For example, in some embodiments, in order to remove any possible reflections, a determination of whether the percentage of foreground pixels is high compared to the number of pixels of the whole scene can be first performed. If the percentage of the foreground pixels is higher than a threshold value, then following can occur. Further details of reflection and shadow removal operations are provided, for example in U.S. patent application Ser. No. 12/982,601, entitled “Searching Recorded Video.”

If there is no current object (i.e., a previously identified object that is currently being tracked) that can be matched to a detected image blob, a new object will be created for the image blob. Otherwise, the image blob will be mapped/matched 555 to an existing object at. Generally, a newly created object will not be further processed until it appears in the scene for a predetermined period of time and moves around over at least a minimal distance. In this way, many false objects can be discarded.

Other procedures and techniques to identify objects of interests (e.g., moving objects, such as persons, cars, etc.) may also be used.

Identified objects (identified using, for example, the above procedure or another type of object identification procedures) are tracked. To track objects, the objects within the scene are classified (at 560). An object can be classified as a particular person or vehicle distinguishable from other vehicles or persons according to, for example, an aspect ratio, physical size, vertical profile, shape and/or other characteristics associated with the object. For example, the vertical profile of an object may be defined as a 1-dimensional projection of vertical coordinate of the top pixel of the foreground pixels in the object region. This vertical profile can first be filtered with a low-pass filter. From the calibrated object size, the classification result can be refined because the size of a single person is always smaller than that of a vehicle.

A group of people and a vehicle can be classified via their shape difference. For instance, the size of a human width in pixels can be determined at the location of the object. A fraction of the width can be used to detect the peaks and valleys along the vertical profile. If the object width is larger than a person's width and more than one peak is detected in the object, it is likely that the object corresponds to a group of people instead of to a vehicle. Additionally, in some embodiments, a color description based on discrete cosine transform (DCT) or other transforms, such as the discrete sine transform, the Walsh transform, the Hadamard transform, the fast Fourier transform, the wavelet transform, etc., on object thumbs (e.g. thumbnail images) can be applied to extract color features (quantized transform coefficients) for the detected objects.

As further shown in FIG. 5, the procedure 500 also includes event detection operations (at 570). A sample list of events that may be detected at block 170 includes the following events: i) an object enters the scene, ii) an object leaves the scene, iii) the camera is sabotaged, iv) an object is still in the scene, v) objects merge, vi) objects split, vii) an object enters a predefined zone, viii) an object leaves a predefined zone (e.g., the pre-defined zone 340 depicted in FIG. 3), ix) an object crosses a tripwire (such as the tripwire 350 depicted in FIG. 3), x) an object is removed, xi) an object is abandoned, xii) an object is moving in a direction matching a predefined forbidden direction for a zone or tripwire, xiii) object counting, xiv) object removal (e.g., when an object is still longer than a predefined period of time and its size is larger than a large portion of a predefined zone), xv) object abandonment (e.g., when an object is still longer than a predefined period of time and its size is smaller than a large portion of a predefined zone), xvi) dwell timer (e.g., the object is still or moves very little in a predefined zone for longer than a specified dwell time), and xvii) object loitering (e.g., when an object is in a predefined zone for a period of time that is longer than a specified dwell time). Other types of event may also be defined and then used in the classification of activities determined from the images/frames.

As described, in some embodiments, data representative of identified objects, objects' motion, etc., may be generated as metadata. Thus, procedure 500 may also include generating 580 metadata from the movement of tracked objects or from an event derived from the tracking. Generated metadata may include a description that combines the object information with detected events in a unified expression. The objects may be described, for example by their location, color, size, aspect ratio, and so on. The objects may also be related with events with their corresponding object identifier and time stamp. In some implementations, events may be generated via a rule processor with rules defined to enable scene analysis procedures to determine what kind of object information and events should be provided in the metadata associated with a video frame. The rules can be established in any number of ways, such as by a system administrator who configures the system, by an authorized user who can reconfigure one or more of the cameras in the system, etc.

It is to be noted that the procedure 500, as depicted in FIG. 5 is only a non-limiting example, and can be altered, e.g., by having operations added, removed, rearranged, combined, and/or performed concurrently. In some embodiments, the procedure 500 can be implemented to be performed with in a processor contained within or coupled to a video source (e.g., capture unit) as shown, for example, in FIG. 1B, and/or may be performed (in whole or partly) at a server such as the computer host system 160. In some embodiments, the procedure 500 can operate on video data in real time. That is, as video frames are captured, the procedure 500 can identify objects and/or detect object events as fast as or faster than video frames are captured by the video source.

### Camera Calibration

As noted, in order to present graphical indications extracted from a plurality of cameras (such as trajectories or moving icon/symbols) on a single global image (or map), it is necessary to calibrate each of the cameras with the global image. Calibration of the cameras to the global image enables identified moving objects that appear in the frames captured by the various cameras in positions/coordinates that are specific to those cameras (the so-called camera coordinates) to be presented/rendered in the appropriate positions in the global image whose coordinate system (the so-called map coordinates) is different from that of any of the various cameras' coordinate systems. Calibration of a camera to the global image achieves a coordinate transform between that cameras' coordinate system and the global image's pixel locations.

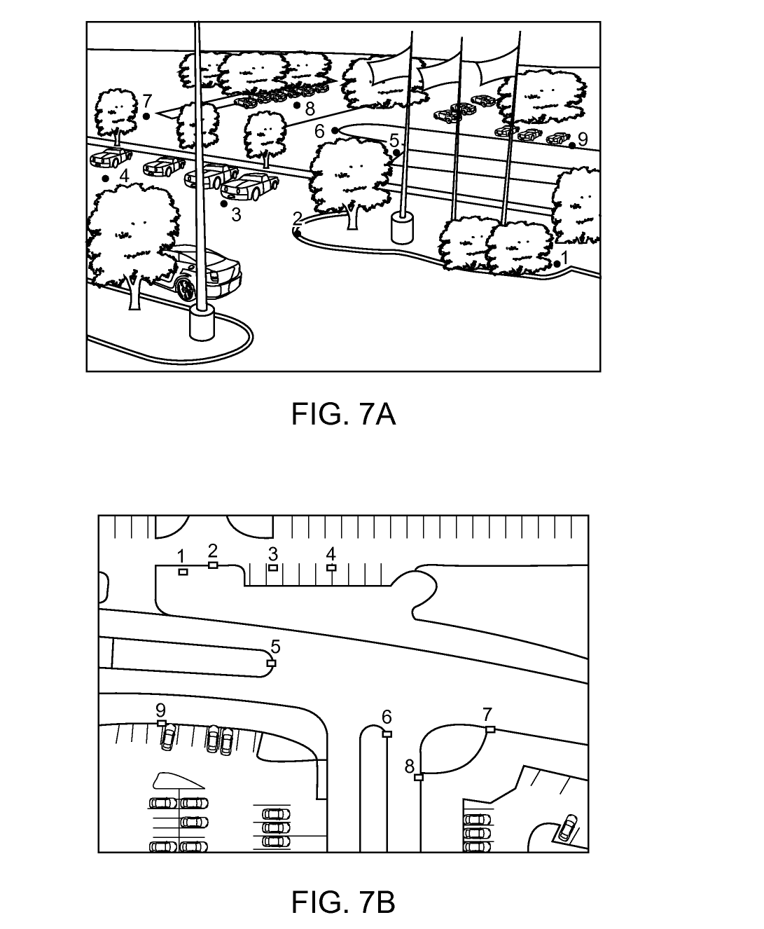

Thus, with reference to FIG. 6, a flowchart of an example embodiment of a calibration procedure 600 is shown. To perform the calibration for one of the cameras to the global image (e.g., an overhead map, such as the global image 300 of FIG. 3) one or more locations (also referred to as calibration spots), appearing in a frame captured by the camera being calibrated, are selected 610. For example, consider FIG. 7A which is a captured image 700 from a particular camera. Suppose that the system coordinate (also referred to as the world coordinates) of the global image, shown in FIG. 7B, is known, and that a small region on that global image is covered by the camera to be calibrated. Points in the global image corresponding to the selected point (calibration spots) in the frame captured by the camera to be calibrated are thus identified 620. In the example of FIG. 7A, nine (9) points, marked 1-9, are identified. Generally, the points selected should be points corresponding to stationary features in the captured image, such as, for example, benches, curbs, various other landmarks in the image, etc. Additionally, the corresponding points in the global image for the selected points from the image should be easily identifiable. In some embodiments, the selection of points in a camera's captured image and of the corresponding points in the global image are performed manually by a user. In some implementations, the points selected in the image, and the corresponding points in the global image, may be provided in terms of pixel coordinates. However, the points used in the calibration process may also be provided in terms of geographical coordinates (e.g., in distance units, such as meters of feet), and in some implementations, the coordinate system of the captured image may be provided in terms of pixels, and the coordinate system of the global image may be provided in terms of geographical coordinates. In the latter implementations, the coordinate transformation to be performed would thus be pixels-to-geographical-units transformation.

To determine the coordinates transformation between the camera's coordinate system and coordinate system of the global image, in some implementations, a 2-dimensional linear parametric model may be used, whose prediction coefficients (i.e., coordinate transform coefficients) can be computed 630 based on the coordinates of the selected locations (calibrations spots) in the camera's coordinate system, and based on the coordinates of the corresponding identified positions in the global image. The parametric model may be a first order 2-dimensional linear model such that:

xₚ=(αₓₓx_{c}+βₓₓ)(α_{xy}y_{c}+β_{xy}) (Equation 1)

yₚ=(α_{yx}x_{c}+β_{yx})(α_{yy}y_{c}+β_{yy}) (Equation 2)

where xₚ and yₚ are the real-world coordinates for a particular position (which can be determined by a user for that selected positions in the global image), and x_{c} and y_{c} are the corresponding camera coordinates for the particular position (as determined by the user from an image captured by the camera being calibrated to the global image). The α and β parameters are the parameters whose values are to be solved for.

To facilitate the computation of the prediction parameters, a second order 2-dimensional model may be derived from the first order model by squaring the terms on the right-hand side of Equation 1 and Equation 2. A second order model is generally more robust than a first order model, and is generally more immune to noisy measurements. A second order model may also provide a greater degree of freedom for parameter design and determination. Also, a second order model can, in some embodiments, compensate for camera radial distortions. A second-order model may be expressed as follows:

xₚ=(αₓₓx_{c}+βₓₓ)²(α_{xy}y_{c}+β_{xy})² (Equation 3)

yₚ=(α_{yx}x_{c}+β_{yx})²(α_{yy}y_{c}+β_{yy})² (Equation 4)

Multiplying out the above two equations into polynomials yields a nine coefficient predictor (i.e., expressing an x-value of a world coordinate in the global image in terms of nine coefficients of an x and y camera coordinates, and similarly expressing a y-value of a world coordinate in terms of nine coefficients of an x and y camera coordinates). The nine coefficient predictor can be expressed as:

$$\begin{matrix}{A}_{9} = [ \begin{matrix}{α}_{22} & {β}_{22} \\ {α}_{21} & {β}_{21} \\ {α}_{20} & {β}_{20} \\ {α}_{12} & {β}_{12} \\ {α}_{11} & {β}_{11} \\ {α}_{10} & {β}_{10} \\ {α}_{02} & {β}_{02} \\ {α}_{01} & {β}_{01} \\ {α}_{00} & {β}_{00}\end{matrix} ] \\ and & ( Equation 5 ) \\ {C}_{9} = [ \begin{matrix}{x}_{c 1}^{2} {y}_{c 1}^{2} & {x}_{c 1}^{2} {y}_{c 1} & {x}_{c 1}^{2} & {x}_{c 1} {y}_{c 1}^{2} & {x}_{c 1} {y}_{c 1} & {x}_{c 1} & {y}_{c 1}^{2} & {y}_{c 1} & 1 \\ {x}_{c 2}^{2} {y}_{c 2}^{2} & {x}_{c 2}^{2} {y}_{c 2} & {x}_{c 2}^{2} & {x}_{c 2} {y}_{c 2}^{2} & {x}_{c 2} {y}_{c 2} & {x}_{c 2} & {y}_{c 2}^{2} & {y}_{c 2} & 1 \\ • & • & • & • & • & • & • & • & • \\ {x}_{cN}^{2} {y}_{cN}^{2} & {x}_{cN}^{2} {y}_{cN} & {x}_{c N}^{2} & {x}_{cN} {y}_{cN}^{2} & {x}_{cN} {y}_{cN} & {x}_{cN} & {y}_{cN}^{2} & {y}_{cN} & 1\end{matrix} ] & ( Equation 6 )\end{matrix}$$

In the above matrix formulation, the parameter α₂₂, for example, corresponds to the term α²ₓₓ α²_{xy} that multiplies the terms x²_{c1}y²_{c1} (when the terms of Equation 3 are multiplied out) where (x_{c1},y_{c1}) are the x-y camera coordinates for the first position (spot) selected in the camera image.

The world coordinates for the corresponding spots in the global image can be arranged as a matrix P that is expressed as:

P=C₉A₉ (Equation 7)

The matrix A, and its associated predictor parameters, can be determined as a least squares solution according to:

A₉=(C₉^{T}C₉)⁻¹C₉^{T}P (Equation 8)

Each camera deployed in the camera network (such as the network 100 of FIG. 1A or the cameras 310a-g shown in FIG. 3) would need to be calibrated in a similar manner to determine the cameras' respective coordinate transformation (i.e., the cameras' respective A matrices). To thereafter determine the location of a particular object appearing in a captured frame of a particular camera, the camera's corresponding coordinate transform is applied to the object's location coordinates for that camera to thus determine the object corresponding location (coordinates) in the global image. The computed transformed coordinates of that object in the global image are then used to render the object (and its motion) in the proper location in the global image.

Other calibration techniques may also be used in place of, or in addition to, the above calibration procedure described in relation to Equations 1-8.

### Auxiliary Cameras

Because of the computational effort involved in calibrating a camera, and the interaction and time it requires from a user (e.g., to select appropriate points in a captured image), it would be preferable to avoid frequent re-calibration of the cameras. However, every time a camera's attributes are changed (e.g., if the camera is spatially displaced, if the camera's zoom has changed, etc.), a new coordinate transformation between the new camera's coordinate system and the global image coordinate system would need to be computed. In some embodiments, a user, after selecting a particular camera (or selecting an area from the global image that is monitored by the particular camera) from which to receive a video stream based on the data presented on the global image (i.e., to get a live video feed for an object monitored by the selected camera) may wish to zoom in on the object being tracked. However, zooming in on the object, or otherwise adjusting the camera, would result in a different camera coordinate system, and would thus require a new coordinate transformation to be computed if object motion data from that camera is to continue being presented substantially accurately on the global image.

Accordingly, in some embodiments, at least some of the cameras that are used to identify moving objects, and to determine the objects' motion (so that the motions of objects identified by the various cameras could be presented and tracked on a single global image) may each be matched with a companion auxiliary camera that is positioned proximate the principal camera. As such, an auxiliary camera would have a similar field of view as that of its principal (master) camera. In some embodiments, the principal cameras used may therefore be fixed-position cameras (including cameras which may be capable of being displaced or having their attributes adjusted, but which nevertheless maintain a constant view of the areas they are monitoring), while the auxiliary cameras may be cameras that can adjust their field of views, such as, for example, PTZ cameras.

An auxiliary camera may, in some embodiments, be calibrated with its principal (master) camera only, but does not have to be calibrated to the coordinate system of the global image. Such calibration may be performed with respect to an initial field of view for the auxiliary camera. When a camera is selected to provide a video stream, the user may subsequently be able to select an area or a feature (e.g., by clicking with a mouse or using a pointing device on the area of the monitor where the area/feature to be selected is presented) that the user wishes to receive more details for. As a result, a determination is made of the coordinates on the image captured by the auxiliary camera associated with the selected principal camera where the feature or area of interest is located. This determination may be performed, for example, by applying a coordinate transform to the coordinates of the selected feature/area from the image captured by the principal camera to compute the coordinates of that feature/area as they appear in an image captured by the companion auxiliary camera. Because the location of the selected feature/area have been determined for the auxiliary camera through application of the coordinate transform between the principal camera and its auxiliary camera, the auxiliary camera can automatically, or with further input from the user, focus in, or otherwise get different views of the selected feature/area without having to change the position of the principal camera. For example, in some implementations, the selection of a graphical movement items representing a moving object and/or its motion may cause the auxiliary camera associated with the principal camera in which the moving object corresponding to the selected graphical movement item appears, to automatically zoom in on the area where the moving object is determined to be located to thus provide more details for that object. Particularly, because the location of the moving object to be zoomed-in on in the principal camera's coordinate system is known, a coordinate transformation derived from calibration of the principal camera to its auxiliary counterpart can provide the auxiliary camera coordinates for that object (or other feature), and thus enable the auxiliary camera to automatically zoom-in to the area in its field of view corresponding to the determined auxiliary camera coordinates for that moving object. In some implementations, a user (such as a guard or a technician) may facilitate the zooming-in of the auxiliary camera, or otherwise adjust attributes of the auxiliary camera, by making appropriate selections and adjustments through a user interface. Such a user interface may be a graphical user interface, which may also be presented on a display device (same or different from the one on which the global image is presented) and may include graphical control items (e.g., buttons, bars, etc.) to control, for example, the tilt, pan, zoom, displacement, and other attributes, of the auxiliary camera(s) that is to provide additional details regarding a particular area or moving object.

When the user finishes viewing the images obtained by the principal and/or auxiliary camera, and/or after some pre-determined period of time has elapsed, the auxiliary camera may, in some embodiments, return to its initial position, thus avoiding the need to recalibrate the auxiliary camera to the principal camera for the new field of view captured by the auxiliary camera after it has been adjusted to focus in on a selected feature/area.

Calibration of an auxiliary camera with its principal camera may be performed, in some implementations, using procedures similar to those used to calibrate a camera with the global image, as described in relation to FIG. 6. In such implementations, several spots in the image captured by one of the cameras are selected, and the corresponding spots in the image captured by the other camera are identified. Having selected and/or identified matching calibration spots in the two images, a second-order (or first-order) 2-dimensional prediction model may be constructed, thus resulting in a coordinate transformation between the two cameras.

In some embodiments, other calibration techniques/procedures may be used to calibrate the principal camera to its auxiliary camera. For example, in some embodiments, a calibration technique may be used that is similar to that described in patent application Ser. No. 12/982,138, entitled “Tracking Moving Objects Using a Camera Network.”

### Implementations for Processor-Based Computing Systems

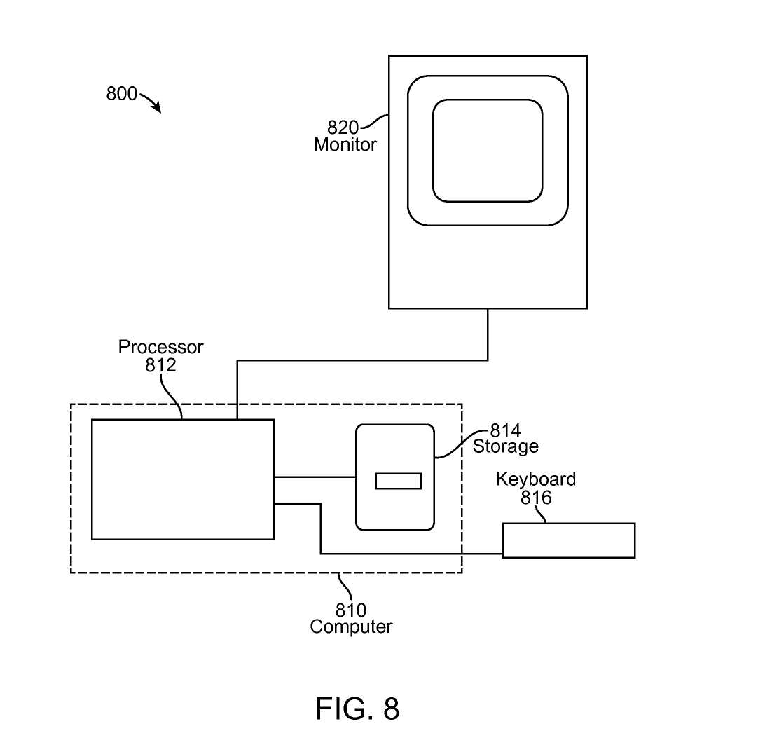

Performing the video/image processing operations described herein, including the operations to detect moving objects, present data representative of motion of the moving object on a global image, present a video stream from a camera corresponding to a selected area of the global image, and/or calibrate cameras, may be facilitated by a processor-based computing system (or some portion thereof). Also, any one of the processor-based devices described herein, including, for example, the host computer system 160 and/or any of its modules/units, any of the processors of any of the cameras of the network 100, etc., may be implemented using a processor-based computing system such as the one described herein in relation to FIG. 8. Thus, with reference to FIG. 8, a schematic diagram of a generic computing system 800 is shown. The computing system 800 includes a processor-based device 810 such as a personal computer, a specialized computing device, and so forth, that typically includes a central processor unit 812. In addition to the CPU 812, the system includes main memory, cache memory and bus interface circuits (not shown). The processor-based device 810 may include a mass storage element 814, such as a hard drive or flash drive associated with the computer system. The computing system 800 may further include a keyboard, or keypad, or some other user input interface 816, and a monitor 820, e.g., a CRT (cathode ray tube) or LCD (liquid crystal display) monitor, that may be placed where a user can access them (e.g., the monitor of the host computer system 160 of FIG. 1A).

The processor-based device 810 is configured to facilitate, for example, the implementation of operations to detect moving objects, present data representative of motion of the moving object on a global image, present a video stream from a camera corresponding to a selected area of the global image, calibrate cameras, etc. The storage device 814 may thus include a computer program product that when executed on the processor-based device 810 causes the processor-based device to perform operations to facilitate the implementation of the above-described procedures. The processor-based device may further include peripheral devices to enable input/output functionality. Such peripheral devices may include, for example, a CD-ROM drive and/or flash drive (e.g., a removable flash drive), or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, etc., may be used in the implementation of the system 800. Other modules that may be included with the processor-based device 810 are speakers, a sound card, a pointing device, e.g., a mouse or a trackball, by which the user can provide input to the computing system 800. The processor-based device 810 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising:
determining, from image data captured by a plurality of cameras, motion data for multiple moving objects;
presenting, on a global image representative of areas monitored by the plurality of cameras, graphical indications of the determined motion data for the multiple objects at positions on the global image corresponding to geographic locations of the multiple moving objects;
presenting captured image data from one of the plurality of cameras in response to selection, based on the graphical indications presented on the global image, of an area of the global image presenting at least one of the graphical indications for at least one of the multiple moving objects captured by the one of the plurality of cameras.

2. The method of claim 1, wherein presenting the captured image data in response to the selection of the area of the global image presenting the at least one of the graphical indications for the at least one of the multiple moving objects comprises:
presenting captured image data from the one of the plurality of cameras in response to selection of a graphical indication corresponding to a moving object captured by the one of the plurality of cameras.

3. The method of claim 1, further comprising:
calibrating at least one of the plurality of the cameras with the global image to match images of at least one area view captured by the at least one of the plurality of cameras to a corresponding at least one area of the global image.

4. The method of claim 3, wherein calibrating the at least one of the plurality of cameras comprises:
selecting one or more locations appearing in an image captured by the at least one of the plurality of cameras;
identifying, on the global image, positions corresponding to the selected one or more locations in the image captured by the at least one of the plurality of cameras; and
computing transformation coefficients, based on the identified global image positions and the corresponding selected one or more locations in the image of the at least one of the plurality of cameras, for a second-order 2-dimensional linear parametric model to transform coordinates of positions in images captured by the at least one of the plurality of cameras to coordinates of corresponding positions in the global image.

5. The method of claim 1, further comprising:
presenting additional details of the at least one of the multiple moving objects corresponding to the at least one of the graphical indications the selected area of the map, the additional details appearing in an auxiliary frame captured by an auxiliary camera associated with the one of the plurality of the cameras corresponding to the selected area.

6. The method of claim 5, wherein presenting the additional details of the at least one of the multiple moving objects comprises:
zooming into an area in the auxiliary frame corresponding to positions of the at least one of the multiple moving objects captured by the one of the plurality of cameras.

7. The method of claim 1, wherein determining from the image data captured by the plurality of cameras motion data for the multiple moving objects comprises:
applying to at least one image captured by at least one of the plurality of cameras a Gaussian mixture model to separate a foreground of the at least one image containing pixel groups of moving objects from a background of the at least one image containing pixel groups of static objects.

8. The method of claim 1, wherein the motion data for the multiple moving objects comprises data for a moving object from the multiple moving objects including one or more of: location of the object within a camera's field of view, width of the object, height of the object, direction the object is moving, speed of the object, color of the object, an indication that the object is entering the field of view of the camera, an indication that the object is leaving the field of view of the camera, an indication that the camera is being sabotaged, an indication that the object is remaining in the camera's field of view for greater than a predetermined period of time, an indication that several moving objects are merging, an indication that the moving object is splitting into two or more moving objects, an indication that the object is entering an area of interest, an indication that the object is leaving a predefined zone, an indication that the object is crossing a tripwire, an indication that the object is moving in a direction matching a predefined forbidden direction for the zone or the tripwire, data representative of counting of the object, an indication of removal of the object, an indication of abandonment of the object, and data representative of a dwell timer for the object.

9. The method of claim 1, wherein presenting, on the global image, the graphical indications comprises:
presenting, on the global image, moving geometrical shapes of various colors, the geometrical shapes including one or more of: a circle, a rectangle, and a triangle.

10. The method of claim 1, wherein presenting, on the global image, the graphical indications comprises:
presenting, on the global image, trajectories tracing the determined motion for at least one of the multiple objects at positions of the global image corresponding to geographic locations of a path followed by the at least one of the multiple moving objects.

11. A system comprising:
a plurality of cameras to capture image data;
one or more display devices; and
one or more processors configured to perform operations comprising:
determining, from image data captured by a plurality of cameras, motion data for multiple moving objects;
presenting, on a global image representative of areas monitored by the plurality of cameras, using at least one of one or more display devices, graphical indications of the determined motion data for the multiple objects at positions on the global image corresponding to geographic locations of the multiple moving objects;
presenting, using one of the one or more display devices, captured image data from one of the plurality of cameras in response to selection, based on the graphical indications presented on the global image, of an area of the global image presenting at least one of the graphical indications for at least one of the multiple moving objects captured by the one of the plurality of cameras.

12. The system of claim 11, wherein the one or more processors configured to perform the operations of presenting the captured image data in response to the selection of the area of the global image are configured to perform the operations of:
presenting, using the one of the one or more display devices, captured image data from the one of the plurality of cameras in response to selection of a graphical indication corresponding to a moving object captured by the one of the plurality of cameras.

13. The system of claim 11, wherein the one or more processors are further configured to perform the operations of:
calibrating at least one of the plurality of the cameras with the global image to match images of at least one area view captured by the at least one of the plurality of cameras to a corresponding at least one area of the global image.

14. The system of claim 13, wherein the one or more processors configured to perform the operations of calibrating the at least one of the plurality of cameras are configured to perform the operations of:
selecting one or more locations appearing in an image captured by the at least one of the plurality of cameras;
identifying, on the global image, positions corresponding to the selected one or more locations in the image captured by the at least one of the plurality of cameras; and
computing transformation coefficients, based on the identified global image positions and the corresponding selected one or more locations in the image of the at least one of the plurality of cameras, for a second-order 2-dimensional linear parametric model to transform coordinates of positions in images captured by the at least one of the plurality of cameras to coordinates of corresponding positions in the global image.

15. The system of claim 11, wherein the one or more processors are further configured to perform the operations of:
presenting additional details of the at least one of the multiple moving objects corresponding to the at least one of the graphical indications in the selected area of the map, the additional details appearing in an auxiliary frame captured by an auxiliary camera associated with the one of the plurality of the cameras corresponding to the selected area.

16. The system of claim 11, wherein the motion data for the multiple moving objects comprises data for a moving object from the multiple moving objects including one or more of: location of the object within a camera's field of view, width of the object, height of the object, direction the object is moving, speed of the object, color of the object, an indication that the object is entering the field of view of the camera, an indication that the object is leaving the field of view of the camera, an indication that the camera is being sabotaged, an indication that the object is remaining in the camera's field of view for greater than a predetermined period of time, an indication that several moving objects are merging, an indication that the moving object is splitting into two or more moving objects, an indication that the object is entering an area of interest, an indication that the object is leaving a predefined zone, an indication that the object is crossing a tripwire, an indication that the object is moving in a direction matching a predefined forbidden direction for the zone or the tripwire, data representative of counting of the object, an indication of removal of the object, an indication of abandonment of the object, and data representative of a dwell timer for the object.

17. A non-transitory computer readable media programmed with a set of computer instructions executable on a processor that, when executed, cause operations comprising:
determining, from image data captured by a plurality of cameras, motion data for multiple moving objects;
presenting, on a global image representative of areas monitored by the plurality of cameras, graphical indications of the determined motion data for the multiple objects at positions on the global image corresponding to geographic locations of the multiple moving objects;
presenting captured image data from one of the plurality of cameras in response to selection, based on the graphical indications presented on the global image, of an area of the global image presenting at least one of the graphical indications for at least one of the multiple moving objects captured by the one of the plurality of cameras.

18. The computer readable media of claim 17, wherein the set of instructions to cause the operations of presenting the captured image data in response to the selection of the area of the global image presenting the at least one of the graphical indications for the at least one of the multiple moving objects comprises instructions that cause the operations of:
presenting captured image data from the one of the plurality of cameras in response to selection of a graphical indication corresponding to a moving object captured by the one of the plurality of cameras.

19. The computer readable media of claim 17, wherein the set of instructions further comprises instructions to cause the operations of:
calibrating at least one of the plurality of the cameras with the global image to match images of at least one area view captured by the at least one of the plurality of cameras to a corresponding at least one area of the global image.

20. The computer readable media of claim 19, wherein the set of instructions one to cause the operations of calibrating the at least one of the plurality of cameras comprises instructions to cause the operations of:
selecting one or more locations appearing in an image captured by the at least one of the plurality of cameras;
identifying, on the global image, positions corresponding to the selected one or more locations in the image captured by the at least one of the plurality of cameras; and
computing transformation coefficients, based on the identified global image positions and the corresponding selected one or more, locations in the image of the at least one of the plurality of cameras, for a second-order 2-dimensional linear parametric model to transform coordinates of positions in images captured by the at least one of the plurality of cameras to coordinates of corresponding positions in the global image.

21. The computer readable media of claim 17, wherein the set of instructions further comprises instructions to cause the operations of:
presenting additional details of the at least one of the multiple moving objects corresponding to the at least one of the graphical indications in the selected area of the map, the additional details appearing in an auxiliary frame captured by an auxiliary camera associated with the one of the plurality of the cameras corresponding to the selected area.

22. The computer readable media of claim 17, wherein the motion data for the multiple moving objects comprises data for a moving object from the multiple moving objects including one or more of: location of the object within a camera's field of view, width of the object, height of the object, direction the object is moving, speed of the object, color of the object, an indication that the object is entering the field of view of the camera, an indication that the object is leaving the field of view of the camera, an indication that the camera is being sabotaged, an indication that the object is remaining in the camera's field of view for greater than a predetermined period of time, an indication that several moving objects are merging, an indication that the moving object is splitting into two or more moving objects, an indication that the object is entering an area of interest, an indication that the object is leaving a predefined zone, an indication that the object is crossing a tripwire, an indication that the object is moving in a direction matching a predefined forbidden direction for the zone or the tripwire, data representative of counting of the object, an indication of removal of the object, an indication of abandonment of the object, and data representative of a dwell timer for the object.
